(19) United States
(12) Patent Application Publication
(10) Pub. No.: US 2026/0302414 A1
(43) Pub. Date: Oct. 1, 2026

(54) SOLID-STATE MODULE AND A MOTOR VEHICLE

(71) Applicant: AUDI AG, Ingolstadt (DE)

(72) Inventors: Dirk HOEFNER, Wellheim (DE); Niklas KELL, Landau (DE); Alexander LEHNEN, Birgden (DE)

(73) Assignee: AUDI AG, Ingolstadt (DE)

(21) Appl. No.: 19/573,308

(22) Filed: Mar. 20, 2026

(30) Foreign Application Priority Data
Mar. 28, 2025 (DE) 102025112155.9

(51) Int. Cl. H01M 10/6554; B60L 50/60; H01M 10/613; H01M 10/625; H01M 10/653; H01M 50/204; H01M 50/249; H01M 50/51

(52) U.S. Cl. CPC H01M 10/6554; H01M 10/613; H01M 10/625; H01M 10/653; H01M 50/204; H01M 50/249; H01M 50/51; B60L 50/60; H01M 2220/20

(57) ABSTRACT

A solid-state cell module, including several solid-state cells arranged in a series in a stacking direction, and two side plates laterally delimiting the solid-state cells. A heat-conducting element is arranged between each of two adjacent solid-state cells, which is thermally connected to the side plates via lateral contact surfaces.

### FIELD

The invention relates to a solid-state battery module and to a motor vehicle comprising such a solid-state battery module.

### BACKGROUND

Electric vehicles, as is well known, use an electric motor which is powered by a high-voltage battery. To provide a sufficiently high operating voltage, these batteries typically consist of at least one battery module in which several individual battery cells are modularly interconnected.

Solid-state cells or solid-state batteries, also known as “all-solid-state batteries,” consist exclusively of solid materials and utilize solid electrolytes in particular. Compared to conventional batteries with liquid electrolytes, they offer crucial advantages: solid electrolytes improve safety properties and enable a higher energy density. Furthermore, the absence of liquid electrolytes significantly reduces the risk of thermal runaway or explosion.

Because of these properties, solid-state batteries are particularly attractive for use in electric vehicles, as they enable greater ranges, shorter charging times and a longer lifespan.

Solid-state cells and solid-state batteries are well known from the prior art. Reference is made to DE 10 2012 203 139 A1 solely by way of example.

Solid-state cells are stacked in series in module integration and are about six times thinner than classic prismatic cells. Due to this small thickness, cooling via the bottom or top side is unsuitable, as the contact surface is too small for effective heat dissipation. Furthermore, the position of the top terminals makes it difficult to integrate a cooling plate. Lateral cooling is also ineffective, as the protective insulating film with its flexural fold hinders heat transfer. The front and back of the cells offer the largest potential heat transfer surface area. However, efficient cooling in this way would require the use of cooling elements between each cell, which would have to be relatively large and correspondingly heavy due to the required cooling capacity. This would result in a significant increase in both module size and weight, making integration into compact battery systems more difficult.

### SUMMARY

The invention is based on the objective of providing a solid-state cell module that enables sufficient cooling of the solid-state cells while requiring little installation space and having low weight.

The solid-state cell module according to the invention comprises several solid-state cells arranged in a series in a stacking direction S and two side plates that laterally delimit the solid-state cells.

The solid-state cell module according to the invention is characterized in that a heat-conducting element is arranged between each of two adjacent solid-state cells, which is thermally connected to the side plates via lateral contact surfaces.

By placing a heat-conducting element between two adjacent solid-state cells, the heat from the cells is transferred via the heat-conducting element and its side surfaces to the side plates and dissipated from there. This avoids the problem of ineffective bottom, top or side cooling and makes cooling elements between the individual cells unnecessary.

A key advantage of this design is that it allows for sufficient cooling while requiring little installation space and weight. While direct cooling of the front or back of the cells using cooling elements would increase the module size and the weight, the heat conduction element allows for efficient heat dissipation without additional, space-consuming cooling elements between the cells. This keeps the module compact and lightweight, while still ensuring reliable temperature control.

A preferred embodiment provides that the heat-conducting elements have a U-shaped cross-section and comprise a base leg extending perpendicular to the stacking direction S, as well as side webs angled orthogonally to this and aligned in the stacking direction S, which form the lateral contact surfaces.

The U-shaped design of the heat-conducting elements offers significant advantages in terms of heat dissipation and material efficiency. The base leg, which runs perpendicular to the stacking direction, efficiently absorbs heat from the solid-state cells, while the side webs, angled orthogonally to it, ensure a large-area thermal coupling to the side plates. This leads to improved heat dissipation, as the heat is specifically transported from the cells via the heat-conducting elements to the side plates and dissipated there.

Furthermore, the specific profile shape contributes to material efficiency. Targeted heat transfer allows for a reduction in material usage, thereby reducing the weight of the entire module. This helps to maintain the compact design without compromising thermal performance.

Preferably, the side plates that laterally delimit the solid-state cells are designed as cooling plates.

Designing the side plates as cooling plates has the effect that the heat generated during operation is dissipated directly and over a large surface area. This ensures a uniform temperature distribution throughout the entire module, thereby avoiding local overheating and maintaining stable performance of the solid-state cells. At the same time, the use of additional, separate cooling systems is eliminated, which reduces the installation space requirement and weight, as well as simplifying system integration. Overall, this embodiment significantly improves the thermal control of the module, thus contributing to increased reliability and longevity of the solid-state cells.

Preferably, the heat-conducting elements are made of a metallic material. This offers the advantage that metallic materials generally have a very high thermal conductivity, which ensures fast and efficient heat dissipation. Furthermore, their mechanical strength and durability contribute to the longevity and reliability of the solid-state cell module, resulting in an overall improvement in the thermal stability and performance of the solid-state cell module.

Preferably, the heat-conducting element is designed in the form of a heat-conducting plate, which offers the advantage that heat-conducting plates have not only excellent thermal conductivity but also excellent mechanical stability. This ensures reliable and efficient heat dissipation, while at the same time enabling the use of cost-effective manufacturing processes. Alternatively, the heat-conducting element can also be designed as a heat-conducting film, which allows for particularly flexible integration as it can be easily adapted to different shapes and applications. Especially in situations where a thinner and more flexible solution is required, thermally conductive film represents an attractive alternative.

The invention also relates to a motor vehicle, in particular an electric vehicle, with a solid-state cell module according to the invention.

All embodiments of the solid-state cell module according to the invention may be transferred analogously to the motor vehicle according to the invention, so that the above-mentioned advantages can also be achieved thereby.

### BRIEF DESCRIPTION OF THE FIGURES

Further advantages and possible uses of the invention will be apparent from the following description in conjunction with the exemplary embodiment depicted in the drawing.

In the drawing:

FIG. 1 is a section of a solid-state cell module according to the invention in a view obliquely from the front;

FIG. 2 is an enlarged view of a solid-state cell with associated heat-conducting elements from FIG. 1, and

FIG. 3 is an enlarged representation of the lateral connection.

### DETAILED DESCRIPTION

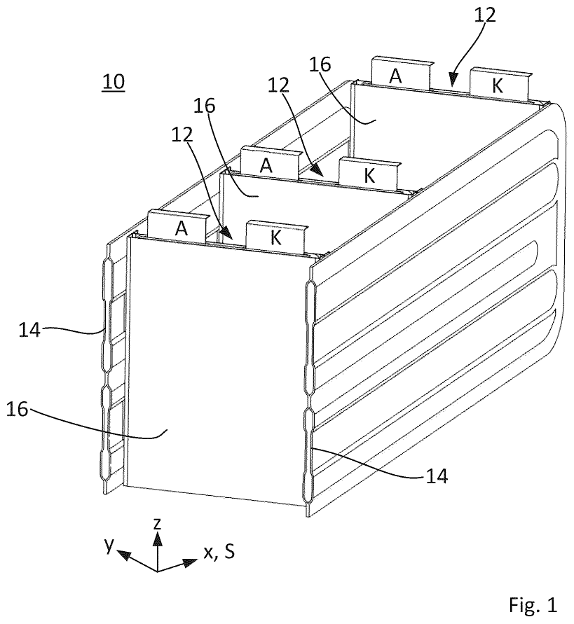

FIG. 1 shows a schematic representation of a section of a solid-state cell module designated as a whole by reference numeral 10.

As can be seen from FIG. 1, the solid-state cell module 10 comprises a plurality of solid-state cells 12 arranged in a series in the stacking direction S or x-direction, as well as two side plates 14 that limit the solid-state cells 12 laterally, i.e. in the y-direction. The side plates 14 are designed as cooling plates, as can be seen in particular from FIG. 1 and FIG. 3. For clarity, only three solid-state cells 12 are shown in FIG. 1.

The reference symbols A and K denote the anode and K of the solid-state cells 12, respectively.

As can be seen in FIG. 1, the solid-state cell module 10 also includes heat-conducting elements 16 arranged between the solid-state cells 12.

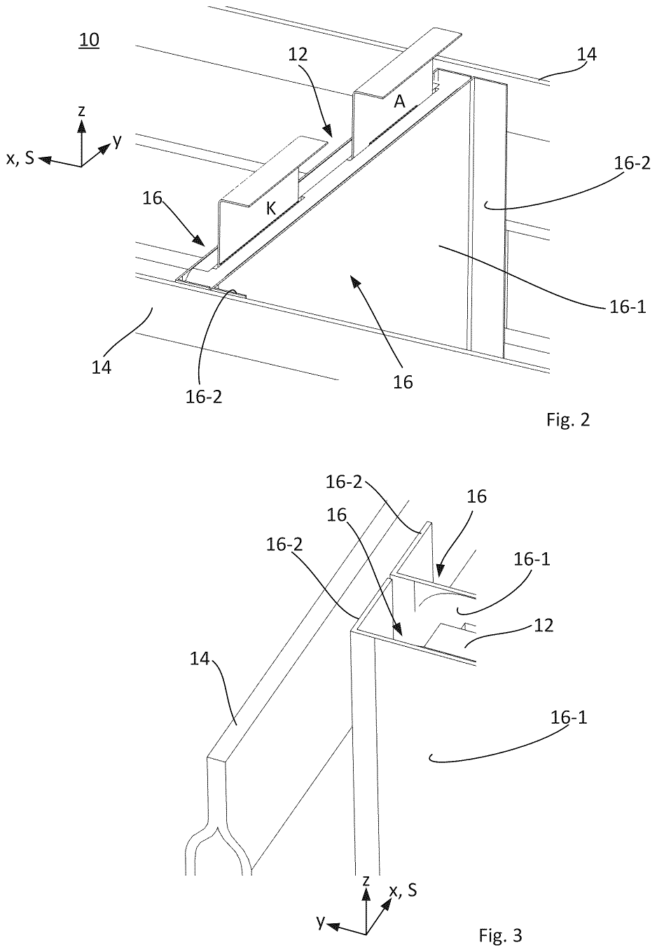

As can be seen particularly from FIG. 2 and FIG. 3, these are designed in a U-shaped cross-section. They comprise a base web 16-1, which runs perpendicular to the stacking direction S, i.e. y-direction, as well as angled side webs 16-2, which are aligned in the stacking direction S, i.e. in the x-direction and are arranged parallel to the side plates 12. While the base web 16-1, which runs perpendicular to the stacking direction S, enables effective heat absorption from the respective adjacent solid-state cell 12, the angled side webs 16-2, whose surfaces facing the side plates 14 form the lateral contact surfaces, ensure a large-area thermal coupling to the side plates 12.

By arranging the heat-conducting elements 16 between adjacent solid-state cells 12, the heat generated in the cells is thus transported and dissipated via their lateral contact surfaces to the side plates 14.

In order to ensure rapid and efficient heat transfer as well as effective heat dissipation, the heat-conducting elements 16 are made of metallic material, in particular in the form of a heat-conducting plate.

A significant advantage of the inventive design of the solid-state cell module 10 lies in the combination of high thermal performance and reduced installation space requirements. The heat-conducting elements 16 provided according to the invention enable effective heat dissipation without the need for additional, space-intensive cooling elements. This results in a compact, lightweight module that ensures reliable temperature control even under demanding operating conditions.

1. A solid-state cell module, comprising several solid-state cells arranged in a series in a stacking direction, and two side plates laterally delimiting the solid-state cells, wherein a heat-conducting element is arranged between each of two adjacent solid-state cells, which is thermally connected to the side plates via lateral contact surfaces.

2. The solid-state cell module according to claim 1, wherein the heat-conducting elements have a U-shaped cross-section and comprise a base leg extending perpendicular to the stacking direction, as well as side webs angled orthogonally to this and aligned in the stacking direction, which form the lateral contact surfaces.

3. The solid-state cell module according to claim 1, wherein the side plates are designed as cooling plates.

4. The solid-state cell module according to claim 1, wherein the heat-conducting elements are made of a metallic material.

5. The solid-state cell module according to claim 1, wherein the heat-conducting elements is designed in the form of a heat-conducting plate.

6. The solid-state cell module according to claim 1, wherein the heat-conducting elements is designed in the form of a heat-conducting film.

7. A motor vehicle comprising a solid-state cell module designed according to claim 1.

8. The solid-state cell module according to claim 2, wherein the heat-conducting elements are made of a metallic material.

9. The solid-state cell module according to claim 3, wherein the heat-conducting elements are made of a metallic material.

10. The solid-state cell module according to claim 2, wherein the heat-conducting elements is designed in the form of a heat-conducting plate.

11. The solid-state cell module according to claim 3, wherein the heat-conducting elements is designed in the form of a heat-conducting plate.

12. The solid-state cell module according to claim 4, wherein the heat-conducting elements is designed in the form of a heat-conducting plate.

13. The solid-state cell module according to claim 2, wherein the heat-conducting elements is designed in the form of a heat-conducting film.

14. The solid-state cell module according to claim 3, wherein the heat-conducting elements is designed in the form of a heat-conducting film.

15. The solid-state cell module according to claim 4, wherein the heat-conducting elements is designed in the form of a heat-conducting film.
